(19) United States
(12) Patent Application Publication
(10) Pub. No.: US 2007/0263574 A1
(43) Pub. Date: Nov. 15, 2007

(54) METHOD AND APPARATUS FOR BATTERY MANAGEMENT IN A CONVERGED WIRELESS TRANSMIT/RECEIVE UNIT

(75) Inventors: Guang Lu, Montreal (CA); Catherine M. Livet, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/537,209

(22) Filed: Sep. 29, 2006

Related U.S. Application Data
(60) Provisional application No. 60/799,196, filed on May 10, 2006.

(51) Int. Cl. H04Q 7/24

(52) U.S. Cl. 370/338

(57) ABSTRACT

The present invention is a method and apparatus for minimizing power consumption in a converged WTRU. In a preferred embodiment, power consumption is minimized by coordinating battery management of the various RATs supported by the converged WTRU. A coordinated multi-RAT battery management (CMRBM) unit is used by the converged WTRU to minimize power consumption. The CMRBM unit monitors various power and link metrics of the various RATs supported by the converged WTRU, and coordinates power states of the converged WTRU.

### CROSS REFERENCE TO RELATED APPLICATION

This application claims the benefit of U.S. Provisional Application No. 60/799,196 filed May 10, 2006, which is incorporated by reference as if fully set forth herein.

### FIELD OF INVENTION

The present invention generally relates to wireless communication systems. More particularly, the present invention relates to power management in a converged wireless transmit/receive unit (WTRU) capable of operating over multiple radio access technologies (RATs).

### BACKGROUND

A converged WTRU is a mobile device capable of communicating via multiple radio access technologies (RATs). A converged WTRU offers rich services including voice, mobile access to e-mail and personal information, web browsing, audio and video playback and streaming, gaming, and the like. However, communicating via multiple RATs requires a large amount of power resulting in the rapid drain of a converged WTRU's battery.

In a converged WTRU, communication via multiple RATs requires the converged WTRU to transmit and receive on each of the multiple RATs. To further compound the problem, a converged WTRU may have multiple RF chains, or may be capable of communicating via multiple RATs simultaneously. Since a converged WTRU is generally a portable device, satisfying power demands by increasing the battery size is not desired. Accordingly, minimizing power consumption in a converged WTRU is desirable.

Of all the components in a converged WTRU, the transceiver generally draws the largest amount of power. Therefore, the simplest way to conserve power is to turn off the transceiver or reduce its activity when it is not required. This may be accomplished by placing the WTRU in a sleep state or discontinuous reception (DRX) mode. Different radio access technologies (RATs) have their own battery saving mechanisms, and two states are generally considered, (sometimes with different terminology than described below).

The first state is the Awake state, where a WTRU's radio is on. In this state, the WTRU can be actively transmitting or receiving data, or the WTRU can be in a power save mode where it generates control traffic to monitor the radio and, if required, quickly switch to active transmission and reception of data. The second state is a Sleep state, where a WTRU's radio is periodically turned off. The WTRU intermittently awakes to receive information from the network, such as, for example, beacons in an IEEE 802.11 RAT, a Pilot Channel (PCH) in a Third Generation Partnership Project (3G) RAT, and the like. The network side may store packets addressed to the sleeping WTRU in a buffer and deliver the packets when the WTRU is in the Awake state.

It should be noted that RAT protocols define the required and optional power management modes for a given technology. To illustrate, in a wireless local area network (WLAN), to reduce battery consumption of the wireless client, the client radio will alternate between two states: (1) active state, where the wireless client is constantly powered actively transmitting and receiving; and (2) power save state that occurs when the wireless client is intermittently sleeping.

WLAN access points in an infrastructure network track the state of every associated WTRU. These access points will buffer the traffic destined for a WTRU in a Sleep state. At fixed intervals, the AP will send out a TIM (Traffic Indication Map) frame indicating which sleeping WTRUs have buffered traffic waiting at the access point. A WTRU in a sleep state will intermittently power on its receiver and receive the TIM. If the WTRU has traffic waiting, it will send a packet switched (PS)-Poll frame to the AP. The WTRU will wait for the traffic until it is received, or the AP will send another TIM frame indicating that there is no buffered traffic.

In universal mobile telecommunication systems (UMTS) technology, a WTRU may be in either one of two basic states, idle state or connected state. In the idle state, the WTRU is “camping on a cell”. However, the WTRU is still able to receive signaling information such as paging. The WTRU will stay in the idle state until a radio resource controller (RRC) connection is established. Various connected state modes are defined in UMTS, including cell dedicated channel (CELL_DCH), cell forward access channel (CELL_FACH), cell paging channel (CELL_PCH), and UMTS terrestrial radio access network (UTRAN) registration area paging channel (URA_PCH), each having varying degrees communication capability and power saving benefits.

Other access technologies have their own respective power management states and modes. The WLAN and UMTS power modes described above are merely exemplary, and are not meant to limit the scope of the present invention, which may be applied to any radio access technology, as desired.

Referring to FIG. 1, a prior art converged WTRU 110 is shown in a multi-RAT wireless environment 100. Various RATs RAT₁, RAT₂, . . . , RAN_{N} are available for communication via their respective protocols. The converged WTRU 110 includes a plurality of RAT processing units 120₁, 120₂, . . . , 120_{N}, for communicating with each RAT₁, RAT₂ . . . RAT_{N}, respectively. The power states of each RAT processing unit 120₁, 120₂, . . . , 120_{N} are controlled by respective RAT battery management units, 130₁, 130₂, . . . , 130_{N}. These RAT battery management units 130₁, 130₂, . . . , 130_{N} manage power and resources in accordance with their respective RAT protocol. The converged WTRU 110 therefore includes functionality for communicating via multiple RATs, and for managing power and resources in accordance with each respective RAT's protocol and power modes. Other WTRU components 140 include various other components and functionality including a display, input devices, transmitter, and the like. To illustrate, when converged WTRU 110 uses RAT₁, RAT₁ processing unit 120₁ provides RAT specific protocol functionality in conjunction with the other WTRU components 140, while RAT₁ battery management unit 130₁ manages power resources and power modes.

However, converged WTRU 110 lacks coordination in that each RAT processing unit 120₁, 120₂, . . . , 120_{N}, and associated RAT battery management unit 130₁, 130₂, . . . , 130_{N}, operate independently of each other. Opportunities for minimizing power consumption are therefore lost. Accordingly, a method and apparatus for coordinating multi-RAT battery management in a converged WTRU is desired.

### SUMMARY

The present invention is a method and apparatus for minimizing power consumption in a converged WTRU. In a preferred embodiment, power consumption is minimized by coordinating battery management of the various RATs supported by the converged WTRU. A coordinated multi-RAT battery management (CMRBM) unit is used by the converged WTRU to minimize power consumption. The CMRBM unit monitors various power and link metrics of the various RATs supported by the converged WTRU, and coordinates power states of the converged WTRU.

### BRIEF DESCRIPTION OF THE DRAWINGS

A more detailed understanding of the invention may be had from the following description, given by way of example and to be understood in conjunction with the accompanying drawings, wherein:

FIG. 1 illustrates conventional battery management in a converged WTRU;

FIG. 2 illustrates a converged WTRU including a coordinated multi-RAT battery management unit according to a preferred embodiment of the present invention;

FIG. 3 is a state machine diagram of the possible power modes of the converged WTRU of FIG. 2;

FIG. 4 is a flow diagram of a method for coordinating multi-RAT battery management in the converged WTRU of FIG. 2;

FIG. 5 is a flow diagram of a method for coordinating multi-RAT battery management using a configuration reports; and

FIG. 6 is a flow diagram of a method for coordinating multi-RAT battery management during inter-RAT handover.

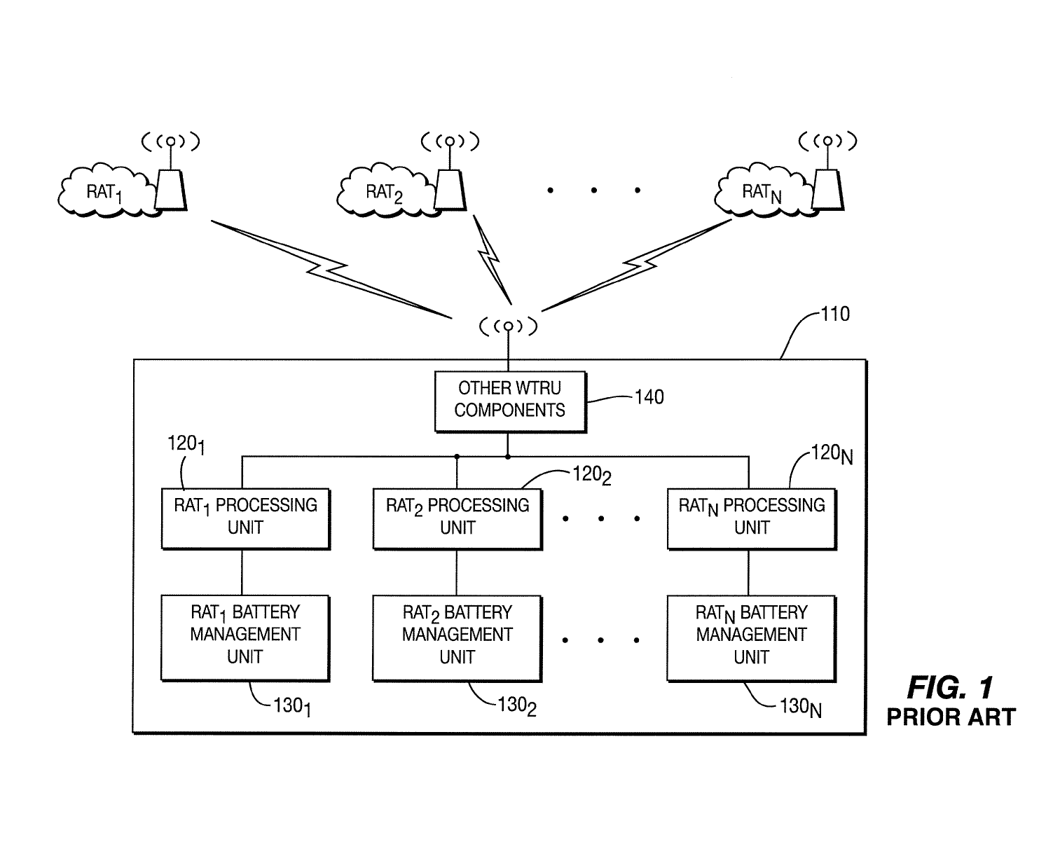

### DETAILED DESCRIPTION OF THE PREFERRED EMBODIMENTS

Although the features and elements of the present invention are described in the preferred embodiments in particular combinations, each feature or element can be used alone (without the other features and elements of the preferred embodiments) or in various combinations with or without other features and elements of the present invention.

As used herein, a WTRU includes but is not limited to a user equipment (UE), a mobile station, a fixed or mobile subscriber unit, a pager, or any other type of device capable of operating in a wireless environment.

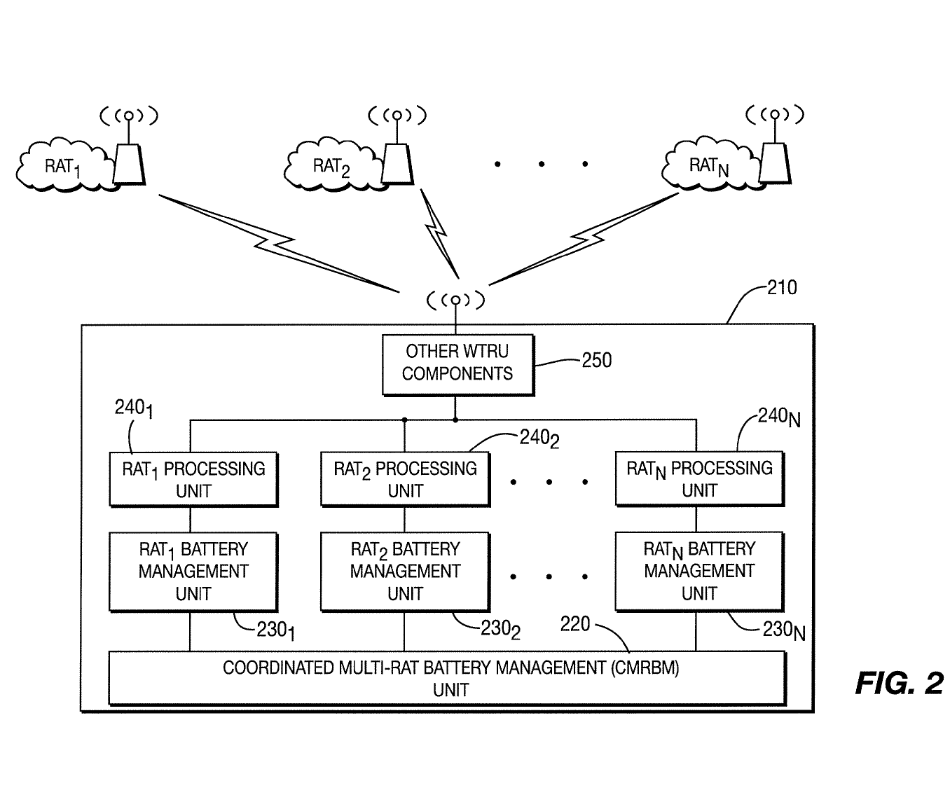

FIG. 2 shows a converged WTRU 210 including a CMRBM unit 220. The CMRBM unit 220 coordinates the various RAT battery management units 230₁, 230₂, . . . , 230_{N}, (collectively referred to herein using reference numeral 230) which in turn control the power and resource management of each respective RAT processing unit 240₁, 240₂, . . . , 240_{N} (collectively referred to herein using reference numeral 240). The multi-RAT wireless communication environment includes RAT₁, RAT₂, . . . , RAT_{N}, which may be, purely by way of example and in no way limiting the scope of the present invention, a general packet radio service (GPRS) network, a universal mobile telecommunication (UMTS) network, a global system for mobile communications (GSM) network, a GSM enhanced data rates for GSM evolution (EDGE) radio access network (GERAN), and a wireless local area network (WLAN), such as an IEEE 802.11x compliant network. The converged WTRU 210 includes other WTRU components 250, which may include a transceiver, memory, display, and the like.

The CMRBM unit 220 coordinates the various RAT battery management units 240₁, 240₂, . . . , 240_{N} of the converged WTRU 210. In order to achieve this, three generic power states are preferably utilized by the CMRBM unit 220. The first power state is the Awake state. In the Awake state, the converged WTRU 210 is actively transmitting and/or receiving data. The CMRBM Awake state is analogous to a WLAN active state and the UMTS connected state, discussed above. The second power state is the Sleep state. In the Sleep state, a RAT is operating with reduced functionality and decreased power consumption, typically powering on only periodically. The Sleep power state is analogous to a UMTS idle state, discussed above. The third power state is the Off state. In the Off state, a RAT is completely powered down and does not periodically transmit or receive traffic.

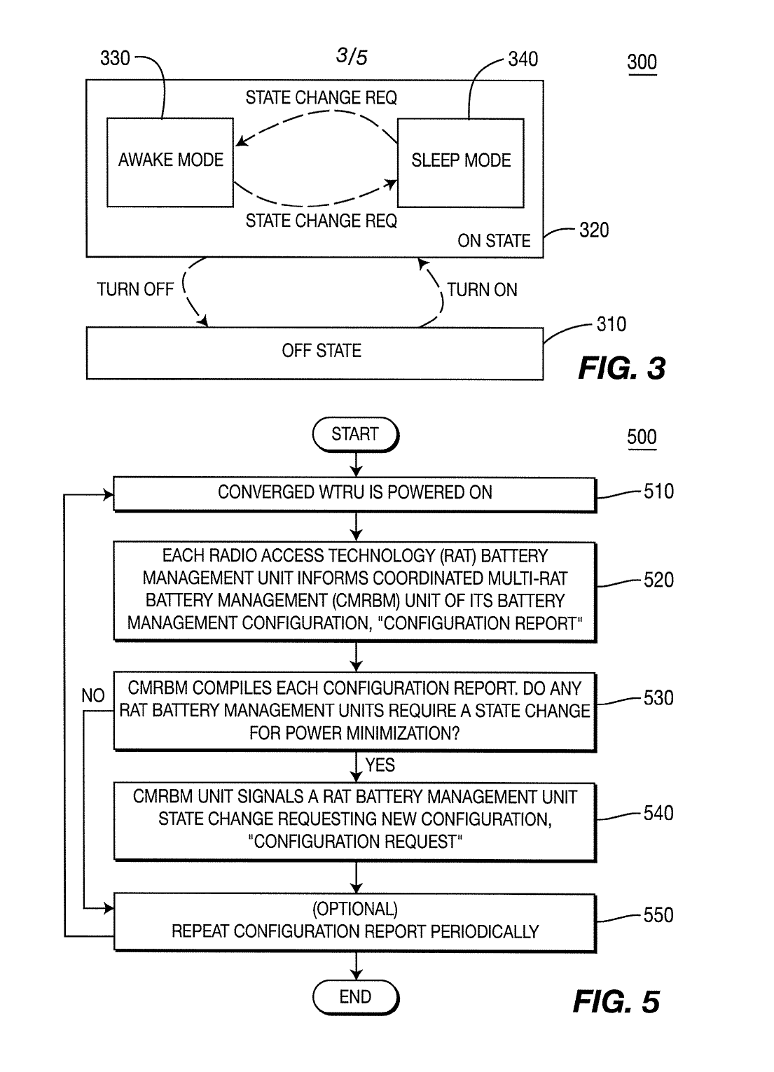

Referring to FIG. 3, a state machine 300 utilized by the CMRBM unit 220 of converged WTRU 210 of FIG. 2 for controlling RAT battery management units is shown. In the Off state 310, a given RAT processing unit is completely powered off. In the ON state 320, a given RAT processing unit is powered and at least partially operational. The ON state 320 further comprises an Awake Mode 330 and a Sleep Mode 340. In the Awake Mode 330, a RAT processing unit is fully operational and may even be actively transmitting data to or receiving data from a network. In the Sleep Mode 340, the RAT processing unit is operating with reduced functionality. Typically, in the Sleep Mode 340, a RAT processing unit will power off its transceiver periodically and reduce control messaging, as described above.

It should be noted that the CMRBM unit 220 power states are generalized power states for use in coordinating multi-RAT battery management. A given RAT protocol may define various sub-states or modes of a given CMRBM power state. For example, the Active state in the UMTS access technology comprises at least four sub-states (URA_PCH, CELL_DCH, CELL_PCH, and CELL_FACH described above). While the CMRBM unit 220 coordinates battery management generally, the specific sub-state selected by a RAT battery management unit is ultimately determined by the RAT battery management unit according to its respective RAT protocol. This is not limited to the Awake Mode 330, and includes the CMRBM Sleep Mode 340, as well as various other power management details that are specific to individual RAT protocols.

Still referring to FIG. 3, a state change is indicated by the dashed lines. A RAT battery management unit may change from the OFF state 310 to the ON state 320, and vice versa, via receipt of a state change request. While in the ON state, a RAT battery management unit may alternate between the Awake Mode 330 and the Sleep Mode 340 by way of a state change request. Alternatively, a RAT battery management unit may unilaterally change its state or mode based on its respective RAT protocol and battery management configuration.

Referring back to FIG. 2, the CMRBM unit 220 preferably communicates with the various RAT battery management units 240₁, 240₂, . . . , 240_{N} of the converged WTRU 210 by way of the messaging primitives detailed, by way of example, in Table 1 below. Other primitives may also be used, and the primitives discussed below may contain additional information elements than those explicitly recited in the description, as desired.

TABLE 1

| Primitive | Direction | Description |
|---|---|---|
| State | CMRBM Unit→ | CMRBM unit requests a RAT battery |
| Change | RAT Battery | management unit to change power states. |
| Request | Management | It is noted that it is ultimately up to the |
| | Unit | RAT battery management unit to execute |
| | | the request. For example, in the UMTS |
| | | RAT, a WTRU can not autonomously |
| | | enter a sleep state; it is a network's |
| | | decision. If a sub-state exists, the sub- |
| | | state is indicated as well. |
| State | CMRBM Unit← | RAT battery management unit indicates |
| Change | RAT Battery | whether its state has changed. The state |
| Indication | Management | change might be the result of a State |
| | Unit | Change Request from the CMRBM unit, |
| | | or an autonomous state change initiated |
| | | by the RAT battery management unit |
| | | based on RAT protocols. The new state is |
| | | indicated in the message. |
| State | CMRBM Unit ← | Prior to a RAT battery management unit |
| Infor- | RAT Battery | autonomously entering anew state, it |
| mation | Management | requests confirmation of state change |
| Request | Unit | from the CMRBM unit. The new state is |
| | | indicated in the message. |
| State | CMRBM Unit → | In response to a State Information |
| Infor- | RAT Battery | Request, the CMRBM unit responds by |
| mation | management | indicating a confirmed state. It is noted |
| Response | Unit | that the ultimate state decision rests |
| | | with the RAT battery management unit. |
| | | The RAT battery management unit |
| | | preferably notifies the CMRBM unit of |
| | | the selected state via a State Change |
| | | Indication message. |
| Turn | CMRBM Unit → | This command allows the CMRBM unit |
| On | RAT Battery | to turn a RAT battery management unit, |
| Request | Management | and in turn the RAT processing unit, On. |
| | Unit | |
| Turn | CMRBM Unit → | This command allows the CMRBM unit |
| Off | RAT Battery | to turn a RAT battery management unit, |
| Request | Management | and in turn the RAT processing unit, Off. |
| | Unit | |
| Configu- | CMRBM Unit ← | A RAT battery management unit |
| ration | RAT Battery | provides internal configuration |
| Report | Management | parameters related to its current power |
| | Unit | state to the CMRBM unit. |
| Configu- | CMRBM Unit → | The CMRBM unit uses this primitive to |
| ration | RAT Battery | customize power state parameters of a |
| Request | Management | RAT so that power consumption is |
| | Unit | optimized. |

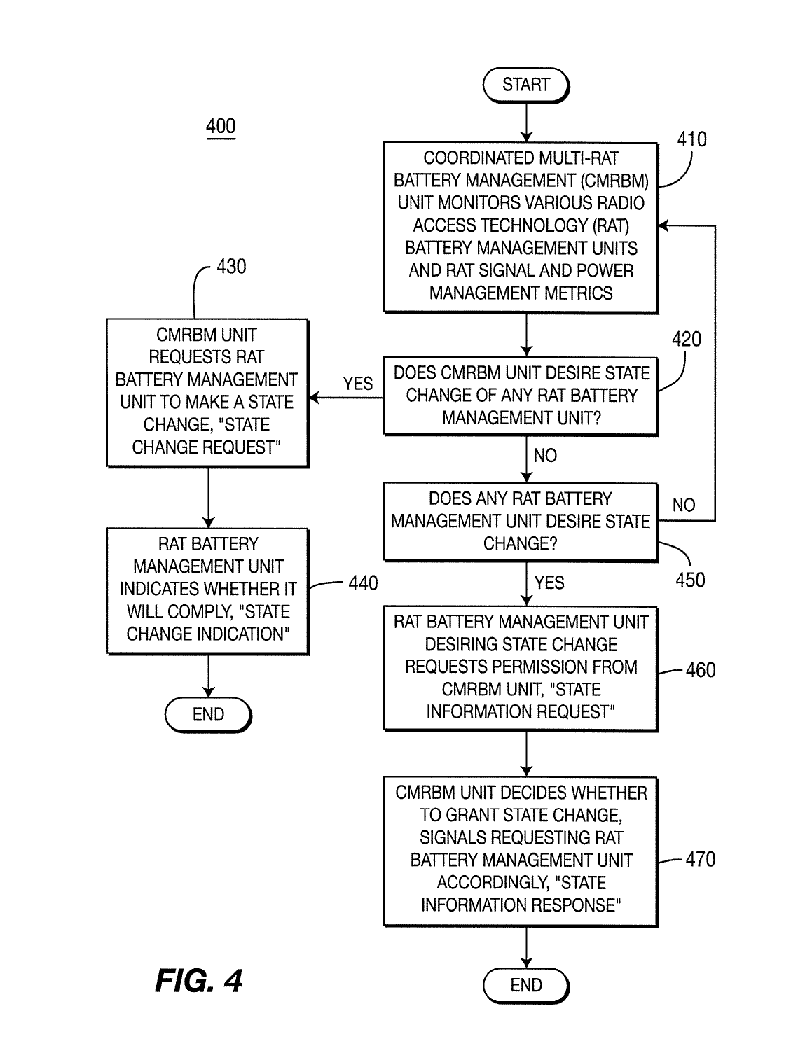

FIG. 4 is a flow diagram 400 of a method for coordinating multi-RAT battery management in the converged WTRU of FIG. 2. The CMRBM unit 220 monitors the various RAT battery management units 240₁, 240₂, . . . ,240_{N} contained in the converged WTRU 210, as well as various signal and link metrics of the RAT, (step 410). Based on this monitoring, the CMRBM unit 220 determines whether a state or mode change of any of the RAT battery management units is desired, (step 420). This determination may be based on any principal for minimizing battery power of the converged WTRU 220. For example, when there is no network of a given RAT available, for example RAT₁, it is desirable to place the corresponding RAT battery management unit 230₁ and RAT processing unit 240₁ in an OFF mode to conserve power. Similarly, if the network becomes available, the RAT battery management unit 230₁ and RAT processing unit 240₁ may then be placed in the ON mode. Alternatively, when the converged WTRU 210 senses a low battery power level, predetermined RAT processing units may be placed in an OFF mode, either permanently or periodically, to conserve battery power.

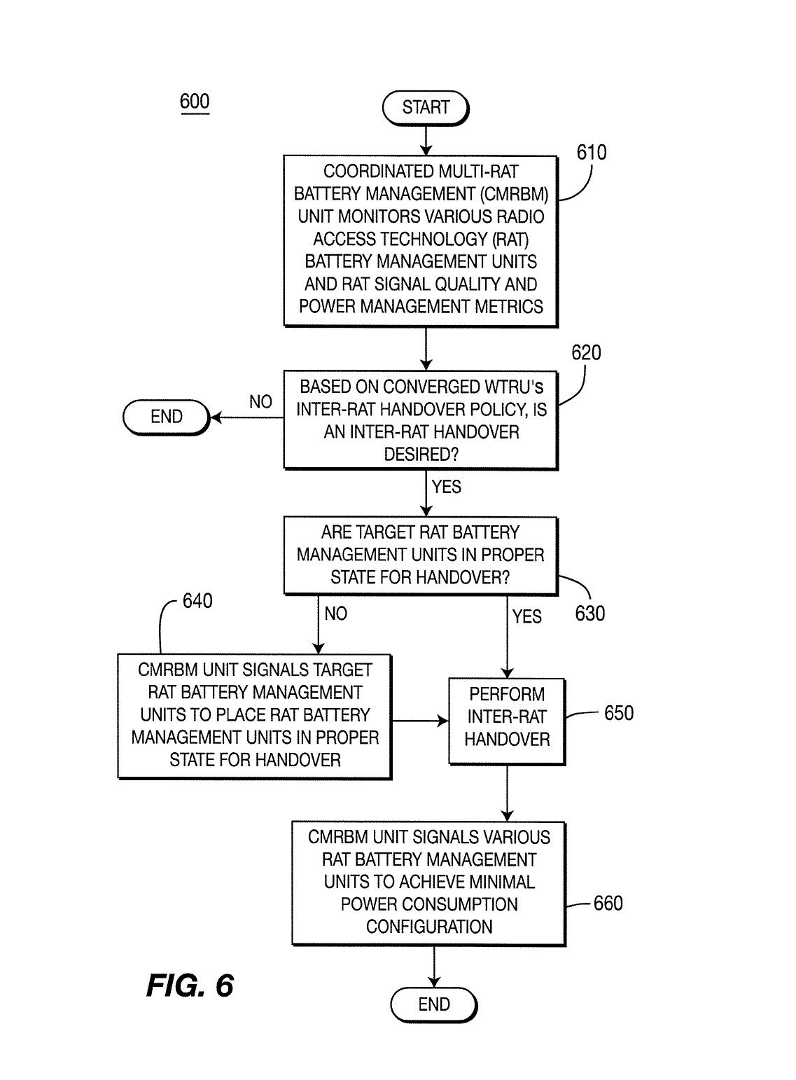

Alternatively, a user of the converged WTRU 210 may configure the CMRBM unit 220 to adjust power modes and states as desired. Alternatively, the CMRBM unit 220 may request the change of state of a RAT battery management unit 230 from Sleep mode to Awake mode, or to refuse the RAT battery management unit 230 to change to Sleep mode based on its respective power management protocol, when a handover to this RAT is imminent, as discussed in greater detail below with reference to FIG. 6. The CMRBM may utilize link quality metrics to affect the state change of any RAT. For example, when the WTRU 210 is connected to several RATs and the link quality is good on these RATs, the CMRBM may request a RAT to change its state to Sleep mode, or vice versa.

In the case where the CMRBM unit 220 determines that a state or mode change is required in step 420, the CMRBM unit 220 requests a RAT battery management unit 230 to make a state or mode change, (step 430). Preferably, the CMRBM unit 220 uses the primitives defined in Table 1 above for requesting the state change. Specifically, the CMRBM unit 220 sends a “State Change Request” message to the RAT battery management unit 230 where a state or mode change is requested. Upon receiving the state change request, the RAT battery management unit 230 indicates whether it will comply with the request, based on its RAT specific protocols, and preferably sends a “State Change Indication” message confirming its current state, (step 440).

It is noted that when a specific RAT changes modes (eg., from an Awake mode to a Sleep mode, or vice versa), the network is typically informed of the mode or state change so that traffic destined for the converged WTRU 210 may be buffered by the network, as discussed above, or for other reasons. The RAT specific protocols for synchronizing power modes with the network are used in order to accomplish this.

If no state change is desired by the CMRBM unit 220 at step 420, it is then determined whether any RAT battery management 230 unit desires a state change, (step 450). A RAT battery management unit 230 may make an independent decision regarding its state based upon RAT specific protocols. If no RAT battery management unit 230 desires a state change, the method returns to step 410 for further monitoring. If a RAT battery management unit 230 desires a state change, the RAT battery management unit 230 requests permission for the state change from the CMRBM unit 220, (step 460). Preferably, the request is a “State Information Request” primitive as detailed above in Table 1. Upon receiving the state change request, the CMRBM unit 220 determines whether to grant the state change request and signals the requesting RAT battery management unit 230 accordingly, (step 470). Preferably, the CMRBM unit 220 signals the requesting RAT battery management unit 230 using a “State Information Response” message as detailed above in Table 1. It is noted that the CMRBM unit 220 may or may not grant the requested state change, and the requesting RAT battery management unit 230 may proceed with the state change regardless of the permission granted or denied by the CMRBM unit 220.

In another embodiment, referring to FIG. 5, a flow diagram 500 of a method for coordinating multi-RAT battery management in converged WTRU 210 using configuration reports is shown. When converged WTRU 210 is powered on, (step 510), each RAT battery management unit 230 informs the CMRBM unit 220 of its respective battery management configuration, (step 520). Preferably, the RAT battery management units 230 send the CMRBM unit 220 a “Configuration Report” message as defined in Table 1 above. It is noted that typically the initial battery management configuration is dictated by the specific RAT protocol. Next, the CMRBM unit 220 compiles the reports and determines the need to request state changes of any of the RAT battery management units 230 so that power consumption is minimized, (step 530). If the CMRBM unit 210 determines no state changes are required (i.e. the converged WTRU 210 is currently operating in the optimum power configuration), the method advances to step 550. If, on the other hand, the CMRBM unit 220 determines a state change is desired (i.e. the converged WTRU 210 could be configured more efficiently), the CMRBM unit 220 requests a RAT battery management unit 230 to make a state change, (step 540). Preferably, this request is in the form of a “Configuration Request” message as defined above in Table 1. The RAT battery management unit 230 requested to change states may then determine, on its own accord, whether to make the state change or not, based on its specific RAT protocol. The chosen state will be indicated by the RAT battery management unit 230 in the next configuration report. Optionally, the various RAT battery management units 230 repeat the configuration reporting periodically, (step 550). The periodic reporting may be at fixed intervals, or may be dynamically adjusted based on user controls, or the CMRBM unit 220.

In addition to the methods described above with reference to FIGS. 4 and 5, the CMRBM unit 220 may request a RAT battery management unit 230 to completely power down, thereby shutting down its respective RAT processing unit 240. This is preferably achieved by sending a “Turn Off Request” message as defined above in Table 1. Similarly, the CMRBM unit 220 may request a RAT battery management unit 230 in a powered down state to turn on. This is preferably achieved by sending a “Turn On Request” message as defined above in Table 1. Converged WTRU 210 may power a RAT battery management unit 230, and thereby a corresponding RAT processing unit 240, on and off in various circumstances to conserve power. For example, where there is no network to scan, when the power supply is below a predetermined threshold, or where a user has not used a specific RAT network for a predetermined amount of time, the CMRBM unit 220 may turn off a RAT battery management unit 230 and corresponding RAT processing unit 240.

In another embodiment, the CMRBM unit 220 provides efficient power management of converged WTRU's 210 various access technologies during inter-RAT handover. In this embodiment, referring to FIG. 6, the CMRBM unit 220 works in conjunction with a converged WTRU's 210 inter-RAT handover policy functionality to improve the execution of an inter-RAT handover by reducing handover delay. Converged WTRU's 210 CMRBM unit 220 monitors various RAT battery management units 230 and RAT signal quality and power management metrics, (step 610). Based on the converged WTRU's 210 inter-RAT handover policy, it is determined whether an inter-RAT handover is desired, (step 620). For example, it may be desirable to transfer active sessions from a RAT network with a low or diminishing link quality to a RAT network with strong or improving link quality. When it is determined that a handover is desired in step 620, it is then determined whether the target RAT processing unit(s) 240 are in an awake state, (step 630). If the target RAT processing unit(s) are not in an awake state, the CMRBM unit 220 signals the target RAT(s) battery management unit(s) 230 to place the target RAT(s) processing unit(s) 240 in an appropriate awake state for handover, step (640). This may be accomplished by either method described above with reference to FIGS. 4 and 5 (i.e. individual RAT signaling or configuration reports). When the target RAT processing unit(s) are in an awake state, the converged WTRU 210 performs inter-RAT handover, (step 650). Finally, the CMRBM unit 220 signals the various RAT battery management units 230 in the converged WTRU 210 so that a minimal power consumption configuration is achieved, (step 660).

For example, when converged WTRU 210 is in an active state using a first RAT processing unit 240₁, but the CMRBM unit 220 senses diminishing link quality (i.e. a predetermined criteria indicating handover), the CMRBM unit 220 requests a second RAT battery management unit 230₂, or plurality of other RAT battery management units 230₂, . . . , 230_{N}, and corresponding RAT processing units 240₂, . . . , 240_{N} that are currently in a sleep state to change to an awake state. The CMRBM unit 220 may select RAT processing units 240₂, . . . ,240_{N} that have the best link quality, or RAT processing units 240₂, . . . , 240_{N} that are best suited to handle the type of traffic transmitted using the first RAT processing unit 240₁. In this manner, a handover target RAT is in an awake state and ready to receive traffic, thereby minimizing handover delay.

What is claimed is:

1. A method for minimizing power consumption in a converged wireless transmit/receive unit (WTRU) capable of transmitting and receiving over a plurality of radio access technologies (RATs), the WTRU having a RAT specific battery management unit for each of the plurality of RATs, the method comprising:
monitoring a power configuration of a plurality of RAT battery management units;
determining whether a power state change is desired in order to minimize power consumption of the WTRU based on the monitoring; and
requesting a power state change of a RAT battery management unit based on the determination.

2. The method of claim 1, further comprising:
receiving the power state change request at a RAT battery management unit;
determining at the RAT battery management unit whether to implement the requested power state change based on a battery management protocol of the RAT battery management unit.

3. The method of claim 2, further comprising:
the RAT battery management unit indicating its compliance with the power state change request.

4. The method of claim 1, wherein determining whether a power state change is desired is further based on link quality metrics.

5. The method of claim 4, wherein if a link quality metric of a RAT is below a predetermined threshold, a change in the power state of a RAT battery management unit associated with the RAT is requested.

6. The method of claim 1, further comprising:
each RAT battery management unit reporting its power management configuration, wherein determining whether a power state change is desired is based on the reporting.

7. The method of claim 6, wherein the reporting is repeated periodically by each RAT battery management unit.

8. The method of claim 1, further comprising:
determining at each RAT battery management unit whether a power state change is desired; and
requesting permission to change power state when the determination is positive.

9. The method of claim 8, further comprising:
making a power state change at a RAT battery management unit desiring a state change upon receiving permission.

10. The method of claim 1, wherein the determination of whether a power state change is required is based on user preference.

11. The method of claim 1, wherein the determination of whether a power state change is required is based on data rates of the plurality of RATs.

12. The method of claim 1, wherein the determination of whether a power state change is required is based on the converged WTRU's inter-RAT handover policy.

13. A converged wireless transmit/receive unit (WTRU) comprising:
a transceiver;
a plurality of radio access technology (RAT) processing units; each RAT processing unit in conjunction with the transceiver configured to transmit and receive over a different RAT;
a plurality of RAT battery management units, one for each RAT processing unit, configured to control a power state of a respective RAT processing unit; and
a coordinated multiple RAT battery management (CMRBM) unit configured to coordinate each of the plurality of RAT battery management units to minimize power consumption.

14. The converged WTRU of claim 13, wherein the CMRBM unit is configured to:
monitor a power configuration of the plurality of RAT battery management units;
determine whether a power state change is desired in order to minimize power consumption of the WTRU based on said monitoring; and
request a power state change of a RAT battery management unit based on said determination.

15. The converged WTRU of claim 13, wherein each RAT battery management unit is configured to receive a power state change request from the CMRBM unit, and to determine whether to implement the requested power state change based on the RAT battery management unit's protocol.

16. The converged WTRU of claim 15, wherein each RAT battery management unit is further configured to indicate its compliance with the power state change request to the CMRBM unit.

17. The converged WTRU of claim 14, wherein the CMRBM unit is further configured to determine whether a power state change is desired based on link quality metrics.

18. The converged WTRU of claim 17, wherein the CMRBM unit is further configured to request a change in the power state of a given RAT battery management unit when a link quality metric of the given RAT is below a predetermined threshold.

19. The converged WTRU of claim 14, wherein each RAT battery management unit is further configured to report its power management configuration.

20. The converged WTRU of claim 19, wherein the reporting is repeated periodically.

21. The converged WTRU of claim 19, wherein the CMRBM unit is further configured to determine whether a power state change is desired based on the reporting.

22. The converged WTRU of claim 13, wherein each RAT battery management unit is configured to:
determine whether a power state change is desired; and
request permission from the CMRBM unit to change power state when the determination is positive.

23. A machine readable storage medium having a stored set of instructions executable by a converged wireless transmit/receive unit (WTRU) for providing coordinated multi-radio access technology battery management, the instructions comprising:
instructions to monitor a power configuration of a plurality of RAT battery management units, determine whether a power state change is desired in order to minimize power consumption of the WTRU based on the monitoring; and to request a power state change of a RAT battery management unit based on the determination.

24. The machine readable storage medium of claim 23, further comprising:
instructions to receive the power state change request at a RAT battery management unit; and to determine at the RAT battery management unit whether to implement the requested power state change based on a battery management protocol of the RAT battery management unit.

25. The machine readable storage medium of claim 24, further comprising:
instructions for the RAT battery management unit to indicate its compliance with the power state change request.

26. The machine readable storage medium of claim 23, wherein determining whether a power state change is desired is based on link quality metrics.

27. The machine readable storage medium of claim 26, further comprising:
instructions to determine if a link quality metric of a RAT is below a predetermined threshold, and to request a change in the power state of a RAT battery management unit associated with the RAT when the determination is positive.

28. The machine readable storage medium of claim 23, further comprising:
instructions for each RAT battery management unit to report its power management configuration, wherein determining whether a power state change is desired is based on the reporting.

29. The machine readable storage medium of claim 28, further comprising:
instructions for each RAT battery management unit to periodically reporting a power management configuration.

30. The machine readable storage medium of claim 23, further comprising:
instructions for each RAT battery management unit to determine whether a power state change is desired, and for a RAT battery management unit to request permission from a coordinated multi-RAT battery management (CMRBM) unit to change power state when the determination is positive.

31. The machine readable storage medium of claim 30, further comprising:
instructions to make a power state change at a RAT battery management unit desiring a state change upon receiving permission from the CMRBM unit.

32. The machine readable storage medium of claim 23, wherein the determination of whether a power state change is required is based on user preference.

33. The machine readable storage medium of claim 23, wherein the determination of whether a power state change is required is based on data rates of the plurality of RATs.

34. The machine readable storage medium of claim 23, wherein the determination of whether a power state change is required is based on the converged WTRU's inter-RAT handover policy.
